(19) United States
(12) Patent Application Publication
(10) Pub. No.: US 2005/0125342 A1
(43) Pub. Date: Jun. 9, 2005

(54) System and method for interactive electronic fund raising and electronic transaction processing

(76) Inventor: Steven Schiff, Stamford, CT (US)

Correspondence Address: Gordon & Jacobson, P.C., 65 Woods End Road, Stamford, CT, 06905, US

(21) Appl. No.: 10/955,839

(22) Filed: Sep. 30, 2004

Related U.S. Application Data
(60) Provisional application No. 60/507,552, filed on Oct. 1, 2003.

(51) Int. Cl. G06F 17/60

(52) U.S. Cl. 705/39

(57) ABSTRACT

A system and methodology for conducting electronic-based transactions. In one aspect, a transaction is conducted using real-time user interaction including recording data representing a specific purpose (or other information) associated with transactions, voice-print authentication of user(s), and/or recording spoken voice of user(s). In another aspect, a system for conducting electronic-based transactions includes a payment processor with input logic, decision logic and output logic. The input logic communicates with a transaction terminal to receive transaction request data (transaction amount and transaction descriptor data). The decision logic selectively authorizes the transaction based upon analysis of the received transaction amount and transaction descriptor data in conjunction with balance information and at least one usage restriction for an account. The output logic generates a status message for communication back to the transaction terminal. In another aspect, an IVR system interacts with callers to conduct donation transactions between callers and caller-selected charitable or political entities.

### CROSS REFERENCE TO RELATED APPLICATIONS

The present application claims priority to Provisional Application No. 60/507,552, filed on Oct. 1, 2003, herein incorporated by reference in its entirety.

### BACKGROUND OF THE INVENTION

1. Field of the Invention

This invention relates broadly to methods and systems for conducting transactions and distributing information through automated or electronic means. More specifically, this invention relates to methodologies and systems for conducting, managing and controlling electronic-based funds transfers, and particularly to electronic fund-raising systems based upon such methodologies and systems.

2. State of the Art

A variety of technology-based funds transfer systems and methodologies exist for gift-giving facilitation and motivation. For example, U.S. Pat. No. 6,519,573 to Shade et al., describes a method and system for electronically transferring charitable gifts. In this system, a host operates a central server. Donors access the central server, select a donation amount and a gift recipient. The gift is then transmitted to the selected recipient, and includes a unique code enabling the recipient to redeem the charitable gift. Subsequently, the recipient visits the host site and selects the charitable gift from a menu of options.

In another example, U.S. Pat. No. 6,253,998 to Ziarno describes a portable electronic terminal to be used in collecting electronic fund-raising monetary contributions. Prospective donors are provided access as the terminal is passed from one to another, and can make contributory transactions utilizing pre-authorized cards. The terminal has manually-activated operators through which donors can designate monetary amounts. Information is entered, recorded, correlated with corresponding donor records, and stored for post-contribution processing.

In U.S. Pat. No. 5,621,640 to Burke et al., an automatic donation system is provided for sales establishments. Data entry functionality is included for entering the price of a product into a cash register, and for entering the amount of cash offered in payment. A card reader keypad receives a card number for accessing data including charity accounts concerning the card. A computer apportions at least a part of any excess cash payment amongst the charity accounts and prints out the apportioned amounts.

Each of these systems suffers from problems that limit their effectiveness in facilitating and motivating the gift-giving process, including limited accessibility, and reliance on paper-bound fund transfer. Moreover, these systems provide for authentication of the donor utilizing traditional mechanisms (e.g., password, PIN), and thus are susceptible to compromise (e.g., identify theft, fraud, etc.). Similarly, such traditional authentication mechanisms fail to provide reliable means for reconciling whether or not a particular donor did in fact make a donation.

In addition, these systems do not enable the donor to specify a purpose (or other restriction) that is associated with the payment for future reference (and/or compliance with the purpose) at the time that the payment monies are distributed by the donee entity as part of its charitable endeavors. It is expected that the enhanced donor control afforded by such features will increase the monetary level of donations to the charitable entity.

### SUMMARY OF THE INVENTION

It is therefore an object of the invention to provide a system and methodology for conducting, managing and controlling electronic-based funds transfers, which is particularly suited for electronic fund-raising applications, money transfer, electronic bill payment, electronic tuition payment, public event information, registration and payment, as well as electronic distribution of funds for the benefit of individuals, such as family members.

It is another object of the invention to provide a system and methodology for conducting electronic-based transactions which provide automatic control over the finalization or termination of the transactions on a transaction-by-transaction basis in accordance with usage restrictions that are associated with a particular account from which payment is to be made.

It is another object of the invention to provide such systems and methodologies which utilize electronic payment processing for funds transfer.

It is a further object of the invention to provide such systems and methodologies which employ voice-print authentication of users.

It is also an object of the invention to provide such systems and methodologies that are highly accessible (e.g., through telephone-based interaction, browser-based interaction over the Internet, or point-of-sale interaction).

It is an additional object of the invention to provide such systems and methodologies that can be accessed at all times of the day and week.

It is still another object of the invention to provide such systems and methodologies that can be accessed at times convenient for the user.

It is still another object of the invention to provide such systems and methodologies that increase the efficiency and decreases the costs associated with such funds transfers.

It is yet another object of the invention to provide such systems and methodologies with increased revenue through sponsorship (e.g., licensing of the naming rights, sponsorship rights, and/or advertising rights) associated with the system.

It is still another object of the invention to provide such systems and methodologies with rewards-based incentives to the users of the system.

In accord with these objects, which will be discussed in detail below, a system and methodology for managing and conducting electronic-based funds transfers is provided that enables real-time interaction with users to conduct transactions of monetary funds from accounts associated with the users. Preferably, the system and methodology is adapted to provide one or more of the following features:
recording data representing usage control information associated with the transactions—the usage control information (e.g., a specific purpose) controls the manner in which the transferred monetary funds are used downstream in the usage chain;
recording data representing usage monitoring information associated with the transactions—the usage monitoring information (e.g., an alert request) controls the manner in which the user can monitor the use of the transferred monetary funds downstream in the usage chain);
authenticating one or more users utilizing a voice print of the user(s); and
recording spoken voice of the user(s) as part of the transactions and storing a representation of the spoken voice as a file in a database for subsequent access thereto.
   Such features can be provided by an interactive voice response system that is operably coupled to the users over a telecommunications network, or by a web server that is operably coupled to the users over the Internet. The system and methodology can be adapted for use in a variety of applications, including: charitable fund raising, political fund raising, money transfer (e.g., Western Union), electronic bill payment, electronic tuition payment, and public event information, registration and payment.

In another aspect of the present invention, a system and methodology for conducting electronic-based transactions are provided that includes a transaction terminal and a financial institution having an account storing funds for a particular entity, wherein payment for the transaction is to be made from the account. A payment processor is provided that includes input logic, decision logic and output logic that cooperate in real-time to selectively finalize or terminate the transaction. The input logic receives transaction request data from the transaction terminal including a transaction amount and transaction descriptor data. The decision logic selectively authorizes the transaction based upon analysis of the received transaction amount and transaction descriptor data in conjunction with balance information and at least one usage restriction for the account. The output logic generates a status message based upon the analysis for communication back to the transaction terminal to finalize or terminate the transaction. In this manner, the system provides automatic regulation of the withdrawal of funds from the account on a transaction-by-transaction basis in accordance with usage restrictions that are associated with the account, which is useful in a wide range of applications such as distribution of funds from charitable entities, from political entities, etc.

In yet another aspect of the present invention, an IVR system is adapted to provide a donation portal hotline that interacts with callers to select a charitable or political entity from a number of charitable or political entities and to conduct a donation transaction between the caller and the selected charitable or political entity through voice-based interaction. This architecture allows a single access telephone number to support voice-activated donation transactions for multiple entities, thereby reducing the telecommunication fees associated with the services. It also provides for automatic interaction with a plurality of callers at all times of the day and week without human involvement on the part of the transaction processing entity during the transaction process. This feature avoids the high costs associated with traditional operator-assisted donation transaction methodologies. The donation portal architecture can also be extended to provide additional voice-activated services, such as the addition of a charitable or political entity, affinity marketing services or other voice-activated services.

Additional objects and advantages of the invention will become apparent to those skilled in the art upon reference to the detailed description taken in conjunction with the provided figures.

### BRIEF DESCRIPTION OF THE DRAWINGS

FIG. 1A is a diagrammatic view of the system organization for an exemplary electronic fund raising system in accordance with the present invention;

FIG. 1B is a diagrammatic view of the system organization for an exemplary electronic fund payment system in accordance with the present invention;

FIG. 2 is a diagrammatic view of the presentment of transaction information stored in the database for efficient data entry and update at the workstation of FIG. 1A;

FIG. 3 is a diagrammatic view of the system organization for an exemplary electronic transaction processing system in accordance with the present invention;

FIGS. 4A-4D, collectively, is a flow chart that illustrates exemplary operations carried out by the merchant transaction terminal, the payment processing gateway, and the charity card processor of FIG. 3 in authorizing payment of a charity card transaction in accordance with the present invention;

FIG. 5 is a diagrammatic view of the system organization of an exemplary computer-based accounting system in accordance with the present invention;

FIGS. 6A-6B, collectively, is a flow chart that illustrates exemplary operations carried out by the staff-user processing logic and the accounts payable processing logic of FIG. 5 in selectively denying payment of an invoice or bill in accordance with the present invention; and

FIG. 7 is an architectural diagram of a donation portal interactive voice response system in accordance with the present invention.

### DETAILED DESCRIPTION OF THE PREFERRED EMBODIMENT

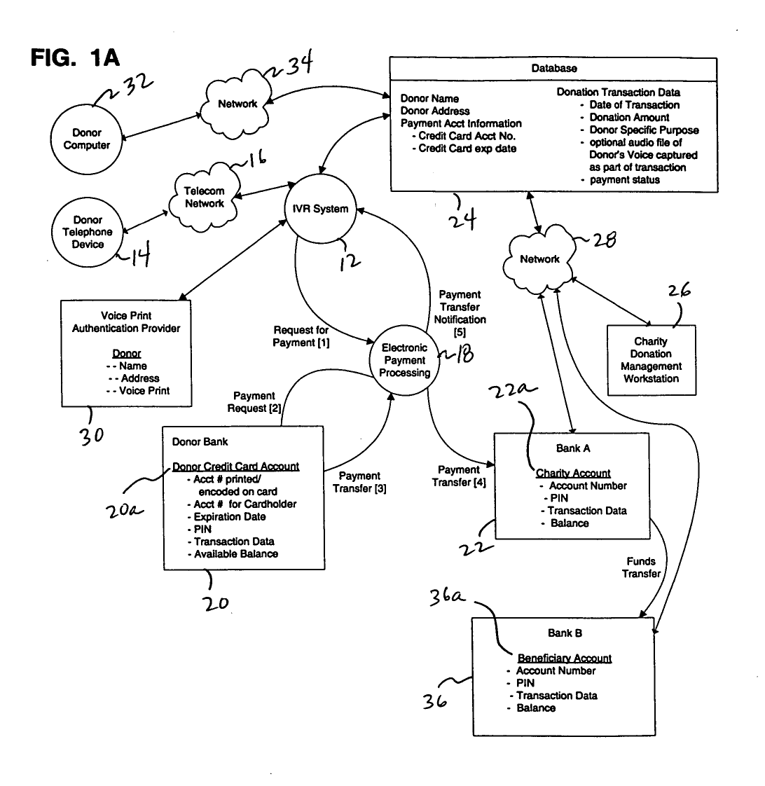

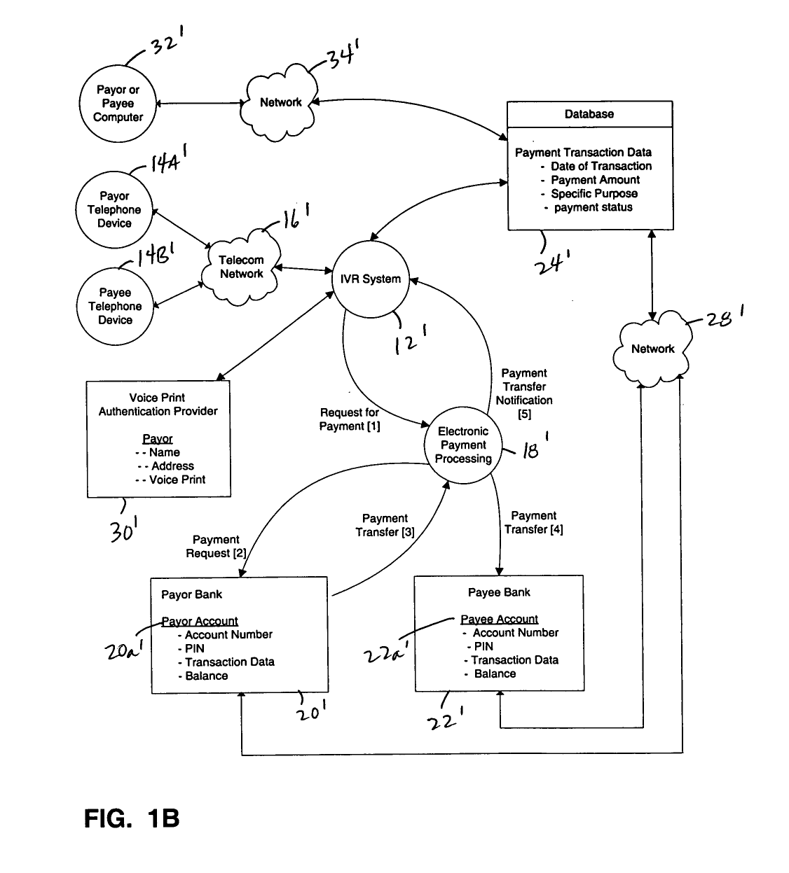

Turning now to FIG. 1A, an electronic fund-raising system in accordance with the present invention includes an interactive voice response (IVR) system 12 that is adapted to interact with a donor-caller (not shown) operably coupled thereto via a telephone device 14 and the telecommunications network 16. The IVR system 12 includes voice scripts and menu options that interact with the donor-caller such that the donor-caller provides (preferably by spoken voice or by other input means) some or all of the following information:
i) the donor's full name;
ii) the donor's address;
iii) usage control information associated with the transaction—the usage control information (e.g., a specific purpose) controls the manner in which the transferred monetary funds are used downstream in the usage chain; and
iv) other information associated with the transaction.
   The IVR system 12 preferably records such spoken voice information (name, address, purpose) as audio files. The voice scripts and menu options of the IVR system 12 also interact with the donor-caller such that the donor-caller enters (by key presses and/or by other user input means) some or all of the following information:
i) the amount of the donation (e.g., dollars);
ii) payment information, such as a credit card account number, or debit card information or bank account number, and the corresponding expiration date of the credit card (or PIN associated with the debit card/bank account);
iii) usage monitoring information associated with the transaction—the usage monitoring information (e.g., an alert request) controls the manner in which a user can monitor the use of the transferred monetary funds downstream in the usage chain; and
iv) other information related to the transaction, such as whether it will be a one-time donation or a recurring donation (e.g., once a year) and contact information (phone number, address, instant message user identifier) for the payor and/or payee.

It is also contemplated that any of this information (e.g., usage control information, usage monitoring information, and donation amount) may be presented to the donor-caller by a voice script and menu option such that the donor-caller selects this information by key presses or other input means.

The operation of the IVR system 12 in acquiring such payment information is described in detail in U.S. Pat. No. 6,307,922, incorporated by reference herein in its entirety.

Preferably, the IVR system 12 interfaces to an electronic payment processing system 18 that enables real-time electronic transfer of funds in the amount of the specified donation amount from the donor's account (e.g., donor's credit card account at donor bank 20) to the bank account of the fund-raising entity (the charity account 22a at bank 22) utilizing well-know electronic payment messages. Such payment messages may pertain to credit card (CC) payments, EFT/ACH payments for checks and debit cards, Electronic Benefit Transfer (EBT) payments, etc. Upon successful transfer of the funds to the fund-raising entity, the electronic-payment processing system 18 provides an electronic notification of such transfer to the IVR system 12. Upon receipt of such notification, the IVR system 12 preferably provides notification of such transfer to the donor-caller via a spoken voice message. For example, as part of a $100 credit card donation, the IVR system 12 may say “$100 dollars have been charged to account XXXX-XXXXXXX.” It is also contemplated that the donor-caller may be “offline” at the time such notification is received. In this case, notification of the completed funds transfer may be provided to the donor-caller via one or more alternative means such as an e-mail, a separate phone call, a text message to a pager/cell phone, or an instant message. The donor-caller may select the preferred mechanism for such notification as part of the transaction or through a registration process.

During the donation transaction (or at some other time such as during a previous transaction), donor information including the donor's name, address, contact information, and payment account information (e.g., a credit card account number, billing address, and expiration date) is stored in a database 24. The database 24 may be a localized data resource or may be a distributed resource such as batch of locatable files distributed across a network. Transaction information including the date of the transaction, donation amount, the audio file captured during the transaction and possibly the payment status (e.g., paid/not-paid) of the transaction is also stored in the database 24 as part of one or more database entries associated with the donation transaction.

Importantly, the IVR system 12 can interact automatically with a plurality of donor-callers at all times of the day and week without human involvement on the part of the fund raising entity during the donation transaction process. This feature avoids the high costs (e.g., telemarketing fees) associated with traditional operator-assisted donation transaction methodologies.

For security purposes, it may be necessary to authenticate the donor before payment is transferred from the donor's account to the charity account. This may be accomplished with traditional authentication mechanisms such as a PIN code or password. Alternatively, more advanced authentication mechanisms based on biometrics such as fingerprints, voice prints or retinal scans can be used. For example, in the system of FIG. 1A, a voice print authentication provider 30 is operably coupled to the IVR system 12. The voice print authentication provider 30 persistently stores voice prints for a plurality of users, one of which is the donor. The IVR system 12 communicates the audio file or a portion thereof captured during the transaction to the voice print authentication provider 30, which compares the donor's voice print persistently stored therein with a sample derived from the audio file to authenticate the donor.

The IVR system 12 and database system 24 may be adapted to enable donor-callers to register their personal information and payment information in the database 24. Preferably, such registration provides the system 12 with a voice-print of the donor-caller (or access thereto) for authentication of the donor-caller. Alternatively, a password, PIN-code, and other authentication mechanism can be generated as part of the registration process. The method of authentication may be customized by the donor-caller (e.g., selection of a password, PIN or voice-print authentication) as part of the registration process. When a registered donor-caller accesses the IVR system 12 for subsequent donations, the registered information is used as part of the donation transaction, thereby minimizing the data entry tasks for subsequent transactions. Moreover, the voice-print and/or other authentication information is used to authenticate the donor-caller prior to requesting electronic payment of funds.

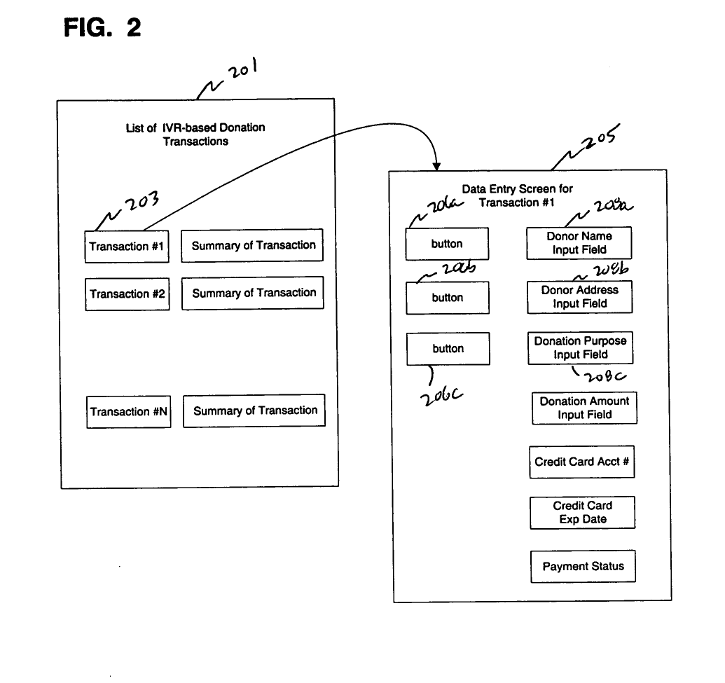

Note that some of the information related to a particular donation transaction (i.e., the donor name, donor address, usage control information, and usage monitoring information) is stored as an audio file(s) in the database 24. In accordance with the present invention, the information related to a particular donation transaction, including the audio file associated therewith, is made accessible to one or more workstations (one shown as 26) over a network connection 28. The transaction information is presented to the user of the workstation(s) 26 in a manner that enables the user to quickly and efficiently play back the audio file associated with a given donation transaction, enter alphanumeric information corresponding to the spoken voice (name, address, specific purpose) captured in the audio file, and update the database 24 with such alphanumeric information. In this manner, the database 24 is efficiently populated with the transaction information that is stored in the audio file. An exemplary graphical user interface that presents the transaction information to the workstation user is discussed below with respect to FIG. 2.

In alternate embodiments, speech recognition technology can be used to automatically convert the spoken voice of the donor-caller to alphanumeric characters for the specific pieces of information described above. Preferably, text-to-speech technology is used in conjunction with the speech recognition technology to ensure the accuracy of the recognition process. In this case, the alphanumeric characters generated by speech recognition are converted into a synthesized voice representation and played to the donor-caller for feedback as to the accuracy of the results. If such feedback is positive (e.g., the results are accurate), the alphanumeric characters generated by speech recognition are added to the appropriate entries of the database. In this manner, some or all of the manual data entry operations for the transaction can be avoided and replaced with automatic data entry functionality. These features can be used to provide for arbitrary free form spoken voice input and accurate conversion of such spoken voice input into digital form.

It is also contemplated that the database 24 may be adapted to provide donor access to the donor information and corresponding transaction data via a computer system 32 operably coupled thereto over a network connection 34 as shown. Such access may be used to enable the donor to specify/update the donor information (e.g., donor address, donor account information, security information, etc) and read/view the transaction data corresponding to the donor. Such access may also be used to enable the donor to update portions of the transaction data, such as the usage control information and/or usage monitoring information associated with the donation transaction.

Aspects of the transaction processing methodologies and systems described above can be readily adapted to other applications, such as other electronic fund-raising applications, money transfer, electronic bill payment, electronic tuition payment, public event information, registration and payment, as well as electronic distribution of funds for the benefit of individuals, such as family members.

FIG. 1B illustrates an exemplary electronic payment processing system in accordance with the present invention. The system enables a first party (denoted the “payor”) to transfer monetary funds to second party (denoted the “payee”). The system includes an interactive voice response (IVR) system 12′ that is adapted to interact with the payor operably coupled thereto via a telephone device 14′ and the telecommunications network 16′. The IVR system 12′ includes voice scripts and menu options that interact with the payor-caller such that the payor-caller provides (preferably by spoken voice or by other input means) some or all of the following information:
i) the payor's full name;
ii) the payor's address;
iii) the payee's full name;
iv) usage control information associated with the transaction—the usage control information (e.g., a specific purpose) controls the manner in which the transferred monetary funds are used downstream in the usage chain; and
v) other information associated with the transaction.
   The IVR system 12′ preferably records such spoken voice information (payor name, payor address, payee name, usage control information, usage monitoring information) as audio files. The voice scripts and menu options of the IVR system 12′ also interact with the payor-caller such that the payor-caller enters (by key presses and/or by other user input means) some or all of the following information:
i) the amount of the transaction (e.g., dollars);
ii) payor payment information, such as a credit card account number, or debit card information or bank account number, and the corresponding expiration date of the credit card (or PIN associated with the debit card/bank account);
iii) payee payment information, such as bank account number; and
iv) usage monitoring information associated with the transaction—the usage monitoring information (e.g., an alert request) controls the manner in which a user can monitor the use of the transferred monetary funds downstream in the usage chain; and
v) other information related to the transaction, such as whether it will be a one-time transfer or a recurring transfer (e.g., once a month), and contact information (phone number, email address, instant message user identifier) for the payor and/or payee.
   It is also contemplated that any of this information (e.g., usage control information, usage monitoring information, and transaction amount) may be presented to the payor-caller by a voice script and menu option such that the payor-caller selects this information by key presses or other input means.

The operation of the IVR system 12′ in acquiring such payment information is described in detail in U.S. Pat. No. 6,307,922, incorporated by reference above.

Preferably, the IVR system 12′ interfaces to an electronic payment processing system 18′ that enables real-time electronic transfer of funds in the amount of the specified transaction amount from the payor's account (e.g., payor's account 20a′ at bank 20′) to the payee's account (the payee account 22a′ at bank 22′) utilizing well-know electronic payment messages. Such payment messages may pertain to credit card (CC) payments, EFT/ACH payments for checks and debit cards, Electronic Benefit Transfer (EBT) payments, etc. Upon successful transfer of the funds to the payee, the electronic-payment processing system 18′ provides an electronic notification of such transfer to the IVR system 12′. Upon receipt of such notification, the IVR system 12′ preferably provides notification of such transfer to the payor-caller via a spoken voice message. It is also contemplated that the payee-caller may be “offline” at the time such notification is received. In this case, notification of the completed funds transfer may be provided to the payee-caller via one or more alternative means such as an e-mail, separate phone call, text message to a pager/cell phone, or an instant message. The payee-caller may select the preferred mechanism for such notification as part of the transaction or through a registration process.

During the transaction (or at some other time such as during a previous transaction), payor information including the name of the payor, the address of the payor, and payment account information (e.g., a credit card account number, billing address, and expiration date) is stored in a database 24′. The database 24′ may be a localized data resource or may be a distributed resource such as batch of locatable files distributed across a network. Transaction information including the date of the transaction, amount, the audio file(s) captured during the transaction and possibly the payment status (e.g., paid/not-paid) of the transaction is also stored in the database 24′ as part of one or more database entries associated with the transaction.

The call processing and transaction processing performed by the IVR system 12′ can be initiated by a phone call from the payor-caller to the IVR system 12′. In this case, the IVR system 12′ has a phone number associated therewith that is dialed to connect to the system 12′. In this configuration, 3-way calling features provided by the telephone service provider may be used to invoke the call processing and transaction processing of the IVR system 12′ simultaneous with (or in conjunction with) a phone call between the payor and the payee. Alternatively, the call and transaction processing operations carried out by the IVR system 12′ can be invoked automatically during a phone call between the payor and payee. This configuration requires that the call between the payor and payee be monitored for the triggering event, and then initiating the call and transaction processing operations of the IVR system 12′ upon detection of the triggering event. The triggering event could be a tone sequence (for example, when the payor or payee enters a predetermined DTMF sequence on the phone), or could be a predetermined voice command spoken by the payor or payee during the call. In these 3-way calling architectures, the payee-caller may be put on hold during the transaction processing (where the payee-caller may hear music, advertisements, or marketing related information), or may listen in on parts or all of the interaction between the payor-caller and the IVT system 12′. The payee-caller may also interact with the IVR system 12′ to provide certain inputs (such as the payee bank account, payee address, or phone number/email).

Importantly, the IVR system 12′ can interact automatically with a plurality of callers at all times of the day and week without human involvement on the part of the transaction processing entity during the transaction process. This feature avoids the high costs associated with traditional operator-assisted transaction methodologies.

For security purposes, it may be necessary to authenticate the payor (and possibly the payee) before payment is transferred from the payor's account to the payee's account. This may be accomplished with traditional authentication mechanisms such as a PIN code or password. Alternatively, more advanced authentication mechanisms based on biometrics such as fingerprints, voice prints or retinal scans can be used. For example, in the system of FIG. 1B, a voice print authentication provider 30′ is operably coupled to the IVR system 12′. The voice print authentication provider 30′ persistently stores voice prints for a plurality of users, one of which is the payor-caller (and possibly the payee-caller). The IVR system 12′ communicates the audio file or a portion thereof captured during the transaction to the voice print authentication provider 30′, which compares the payor-caller's voice print persistently stored therein with a sample derived from the audio file to authenticate the payor (or payee).

The IVR system 12′ and database system 24′ may be adapted to enable payor-callers (and possibly payee-callers) to register their personal information and payment information in the database 24′. Preferably, such registration provides the system 12′ with a voice-print of the caller (or access thereto) for authentication of the caller. Alternatively, a password, PIN-code, and other authentication mechanism can be generated as part of the registration process. The method of authentication may be customized by the caller (e.g., selection of a password, PIN or voice-print authentication) as part of the registration process. When a registered caller accesses the IVR system 12′ for subsequent payments, the registered information is used as part of the transaction, thereby minimizing the data entry tasks for subsequent transactions. Moreover, the voice-print and/or other authentication information is used to authenticate the caller prior to requesting electronic payment of funds.

Note that some of the information related to a particular transaction (i.e., the payor name, payor address, usage control information, and/or usage monitoring information) is stored as an audio file(s) in the database 24′. In accordance with the present invention, the information related to a particular transaction, including the audio file(s) associated therewith, is made accessible to one or more workstations (not shown) over a network connection 28′. The transaction information is presented to the user of the workstation(s) in a manner that enables the user to quickly and efficiently play back the audio file(s) associated with a given transaction, enter alphanumeric information corresponding to the spoken voice (name, address, specific purpose) captured in the audio file(s), and update the database 24′ with such alphanumeric information. In this manner, the database 24′ is efficiently populated with the transaction information that is stored in the audio file.

In alternate embodiments, speech recognition technology can be used to automatically convert the spoken voice of a caller to alphanumeric characters for the specific pieces of information. Preferably, text-to-speech technology is used in conjunction with the speech recognition technology to ensure the accuracy of the recognition process. In this case, the alphanumeric characters generated by speech recognition are converted into a synthesized voice representation and played to the caller for feedback as to the accuracy of the results. If such feedback is positive (e.g., the results are accurate), the alphanumeric characters generated by speech recognition are added to the appropriate entries of the database. In this manner, some or all of the manual data entry operations for the transaction can be avoided and replaced with automatic data entry functionality. These features can be used to provide for arbitrary free form spoken voice input and accurate conversion of such spoken voice input into digital form.

Referring back to FIG. 1A, it is also contemplated that the database 24 may be adapted to provide network access to the information and corresponding transaction data stored therein via a computer system 32 operably coupled thereto over a network connection 34 as shown. Such network access may be used to enable donors to specify/update their information (e.g., address, contact information, account information, security information, etc) and read/view the transaction data corresponding to their transaction(s). Such access may also be used to enable the donors to update portions of the transaction data, such as allowing the donor to update the usage control information and/or usage monitoring information associated with the donation transaction. Similar features can be readily adapted into the transaction processing system of FIG. 1B to allow the payor and/or payee access to the transaction information stored in the database 24′.

FIG. 2 illustrates an exemplary graphical user interface for the presentation of donation transactions at the workstation 26 in accordance the present invention. It includes a window 201 that displays a list of donor transactions conducted by the IVR system 12. The user selects one of the transactions (for example, by clicking on a button 203 associated therewith), which triggers the display of window 205. Window 205 displays information associated with a particular donation transaction. More particular, window 205 includes buttons 206a, 206b, 206c that are positioned alongside data entry fields 208a, 208b, 208c for the donor name, donor address and usage control information (e.g., donation purpose/restriction), respectively. By clicking on the button 206a, the audio file that stores the donor name as provided by the spoken voice of the donor is played. While the user listens to the playback of the file, the user transcribes the donor name into the donor name input field 208a. Similarly, by clicking on the button 206b, the audio file that stores the donor address as provided by the spoken voice of the donor-caller is played. While the user listens to the playback of the file, the user transcribes the donor address into the donor address input field 208b. Finally, by clicking on the button 206c, the audio file that stores the usage control information as provided by the spoken voice of the donor-caller is played. While the user listens to the playback of the file, the user transcribes the usage control information into the purpose/restriction input field 208c. Window 205 also displays the donation amount and payment information for the particular donation transaction as shown. In alternate embodiments, speech recognition technology can be used to aid in (or replace) the conversion of the spoken voice of a caller to alphanumeric characters as set forth above.

It is also contemplated that the electronic transaction processing system of the present invention can be adapted to provide additional monetary value to the transaction processing entity. For example, licensing fees may be collected by the transaction-processing entity for adapting an introductory voice script presented from the IVR system to each caller. The introductory voice script may identify a particular person, organization or brand information as part of advertising and naming rights that are licensed in exchange for fees paid to the transaction processing entity. For example, the introductory voice script may communicate that transaction made through the system are “in memory of” a particular person or “provided by” a particular commercial entity.

It is contemplated that the usage control information associated with a particular transaction in the database will be accessed downstream in the usage chain. For example, such information can be used by a fund raising entity as part of its charitable endeavors to provide advisory information in the distribution of funds to third parties. It can also be used to ensure that the funds associated with the transaction are used in accordance with a specified purpose/restriction as is discussed below. For example, it can be used to ensure the transaction funds are used to buy perishable food stuffs for a beneficiary of the charitable entity.

It is also contemplated that the usage monitoring information associated with a particular transaction will be accessed in the usage chain. For example, the usage monitoring information can be used to trigger the generation and communication of an alert message that is sent to the donor/payor/payee when the transaction funds are used (e.g., paid to a third party), when the available balance of the transaction funds (which is updated based upon payment of the transaction funs) reaches a predetermined limit, or other conditions associated with the transaction funds. In another example, the usage monitoring information can be used to trigger the generation and communication of a report that is sent to the donor/payor/payee that describes how and possibly when the transaction funds are used (e.g., paid to a third party).

In addition, it is contemplated that the audio files stored in the database can be accessed and played back by the transaction processing entity in the event that the accuracy and/or existence of any part of the transaction is questioned by a party of the transaction or a third party. This feature enables efficient reconciliation of any inaccuracies (whether perceived or real) that are identified in the transaction information stored in the database.

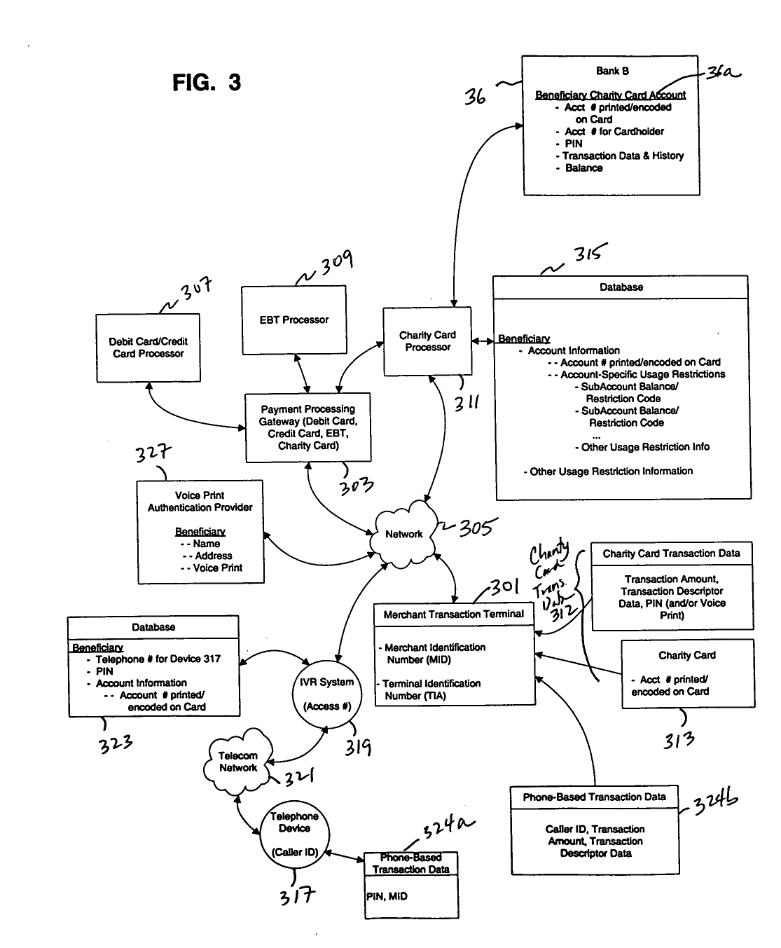

For charitable applications, the funds held in the charity account 22a of FIG. 1A are managed by the charity preferably through a network connection between a charity computing system, e.g., the workstation 26, and the bank 22 as shown. Portions of these funds are transferred to one or more beneficiary bank accounts (one shown as the beneficiary account 36a at bank 36). The banks 22 and 36 are shown as two separate institutions for illustrative purposes only. It is contemplated that a single institution may handle both the charity account 22a and the beneficiary account 36a. The beneficiary account 36a exists for the benefit of a beneficiary of the charity. The beneficiary is a person or an entity that has been selected by the charity to receive monetary aid from the charity. For charity card transactions (as described below in detail with reference to FIG. 3), the beneficiary bank 36 issues a charity card 313 to a beneficiary. The charity card 313 utilizes a magnetic strip, a semiconductor memory, radio frequency identification circuitry, or other electronic means to encode a beneficiary account number and possibly other information. The beneficiary account number is a unique sequence of numbers that identifies the issuing bank (bank 36) in addition to the beneficiary account 36a that stores monetary funds for the benefit of the beneficiary. The beneficiary account number may also be printed on the surface of the charity card.

In accordance with the present invention, an electronic fund-distribution system is provided that automatically regulates the withdrawal of funds from the beneficiary account 36a on a transaction-by-transaction basis in accordance with usage restrictions that are associated with the beneficiary account 36a. The usage restrictions can be defined by the charity in a flexible manner to vary the regulation scheme for different beneficiaries. In addition, such usage restrictions can be defined to correspond to a diverse range of usage controls (e.g., “purposes”) as specified by donors during fund raising, for example as part of the electronic fund raising system described above. In this manner, the withdrawal of funds by the beneficiary can be automatically regulated to conform to the specific purpose(s) dictated by a given donor during fund raising.

An example of an electronic transaction processing system in accordance with the present invention is shown in FIG. 3. It includes a merchant transaction terminal 301, typically referred to as a point-of-sale machine, which is located within a retail store. The merchant transaction terminal 301 interfaces to a payment processing gateway 303 via a data communication network 305 as shown. The payment processing gateway 303 interfaces to a plurality of payment processors, including but not limited to a debit card/credit card payment processor 307, an EBT payment processor 309 and a charity card processor 311. The merchant transaction terminal 301 cooperates with the payment processing gateway 303 to support different transaction types, including credit card transactions, debit card transaction, EBT transactions and charity card Transactions.

For credit card, debit card and EBT transactions, an Issuer financial institution issues the card to an individual cardholder. The merchant transaction terminal 301 typically swipes the magnetic strip on this card and contacts the payment processing gateway 303 for authorization by transmitting the transaction information electronically over the network 305. The gateway 303 forwards the transaction information to the appropriate payment processor (either the debit card/credit card payment processor 307 or the EBT payment processor 309), which communicates with the Issuer for the card (not shown) to retrieve the cardholder's account information. If the card is valid and the cardholder has an available account balance that is sufficient to pay for the transaction, the processor (307 or 309) returns an authorization to the gateway 303, which in turn returns the authorization to the merchant transaction terminal 301. If the card is not valid or the available account balance is insufficient to pay for the transaction, the processor (307 or 309) returns an error to the gateway 303, which in turn returns the error to the transaction terminal 301. After receiving authorization, the merchant transaction terminal 301 records the sale and prints a sales receipt that is given to the customer/cardholder. If an error is received, the sale is declined. On a periodic basis (e.g., such as a daily basis), such sales are submitted either in electronic form or paper form to one or more third party acquirers. The acquirer(s) essentially buys the card transactions and credits their value (typically less a processing fee) to the merchant's account. In turn, the third party acquirer(s) collect payment from the Issuer. This settlement process is typically carried out through a network of processors. The Issuer then charges the transaction against the cardholder's account.

For charity card transactions, the beneficiary (or the beneficiary's representative or the check out clerk) employs the merchant transaction terminal 301 to swipe the magnetic strip on the charity card 313 (or to access the semiconductor memory, radio frequency identification circuitry, or other electronic means of the charity card 313) and contacts the payment processing gateway 303 for authorization by transmitting the transaction information electronically over the network 305. The gateway 303 forwards the transaction information to the charity card processor 311. Alternatively, the merchant transaction terminal 301 can contact the charity card processor 311 directly over the network 305.

The transaction information communicated from the merchant transaction terminal 301 to the charity card processor 311 identifies the following:
i) the beneficiary account number printed/encoded on the charity card 313;
ii) the transaction amount;
iii) descriptor data pertaining to the transaction; and
iv) optionally, other data such as a PIN or Voice Print supplied by the beneficiary cardholder.
   The information items ii)-iv) as set forth above are collectively labeled charity card Transaction Data 312 as shown. The descriptor data pertaining to the transaction corresponds to the goods or services purchased as part of the transaction, and/or to the types of goods or services purchased as part of the transaction. For example, the descriptor data may be one or more codes assigned to the goods or services purchased as part of the transaction, or one or more codes assigned to the type of goods or services purchased as part of the transaction. Alternatively, the descriptor data may include alphanumeric text that describes the goods or services purchased as part of the transaction.

The charity card processor 311 maintains or accesses a database 315 which stores information pertaining to the beneficiaries of the charity. More particularly, the database 315 stores account information (e.g., the beneficiary account number printed/encoded on the charity card 313) for each beneficiary along with account-specific usage restrictions and possibly other usage restrictions. The database 315 may be a localized data resource or may be a distributed resource such as batch of locatable files distributed across a network. The database 315 may be maintained by the charity card processor 311, the bank 36 or possibly another entity.

In processing a given charity card transaction, the charity card processor 311 communicates with the beneficiary bank 36 for the charity card 313 to retrieve the beneficiary cardholder's account information, including the available balance in the account. If the charity card is valid, the charity card processor 311 analyzes the available account balance in conjunction with the transaction descriptor data supplied from the merchant transaction terminal 301 and the usage restrictions stored in the database 315 to determine whether there is sufficient funds in the account to pay for the transaction and whether the transaction is not blocked by any usage restriction that pertains to the account (or to the beneficiary). If these conditions are satisfied, the charity card processor 311 returns an authorization to the gateway 303, which in turn returns the authorization to the merchant transaction terminal 301. If the card is not valid or if any one of these conditions is not satisfied, the credit card processor 311 returns an error to the gateway 303, which in turn returns the error to the transaction terminal 301. After receiving authorization, the merchant transaction terminal 301 records the sale and prints a sales receipt that is given to the customer/charity cardholder. If an error is received, the sale is declined. Preferably, settlement of the sale is accomplished though a mechanism similar to that performed for credit card/debit card sales. Upon settlement, the beneficiary bank 36 charges the transaction amount against the beneficiary's account 36a and adds information pertaining to the transaction to the transaction data maintained by the beneficiary bank 36. Such transaction data is preferably reported to the beneficiary account holder at regular intervals and is also readily accessible via network access (such as over the Internet or through a financial management software application, e.g., Quicken®).

Alternatively, the electronic transaction processing system may enable the beneficiary to pay for the goods or services utilizing a telephone-based transaction whereby the beneficiary caller utilizes a telephony device 317, e.g. a wireless cell phone device or PDA, to call an IVR system 319 at a predetermined access number. The IVR system 319 is adapted to interact with the beneficiary-caller operably coupled thereto via the telephone device 317 and the telecommunications network 321. During such interaction, the IVR system 319 cooperates with a database 323 that stores beneficiary information to authenticate the beneficiary-caller. For example, the database 323 may store financial account information, an access PIN, and the telephone number of the beneficiary's telephone device 317 whereby authentication is accomplished by matching the caller ID of the call to the beneficiary's telephone number stored in the database 323 and matching a caller-supplied PIN to the access PIN of the beneficiary stored in the database 323. The database 323 may be a localized data resource or may be a distributed resource such as batch of locatable files distributed across a network. The database 323 may be maintained by the charity card processor 311, the bank 36 or possibly another entity.

After authenticating the beneficiary, the IVR system 319 communicates the beneficiary account information along with “other” transaction information to the charity card processor 311 over the network 305. The “other” transaction information may include the caller ID of the call (the telephone number of the telephone device 317) and the merchant identifier MID which is provided to the beneficiary-caller by the merchant at the point of sale). The caller-supplied PIN and the merchant identifier MID are collectively labeled Phone Transaction Data 324a as shown. Such communication may possibly flow indirectly through the payment processing gateway 303.

In conjunction with such communication by the IVR system 319, the merchant transaction terminal 301 requests authorization of the transaction by communicating transaction-related information (the transaction amount, and the transaction descriptor data as described above), the merchant identifier MID assigned to the merchant transaction terminal 301, as well as “other” transaction information to the charity card processor 311. The “other” transaction information forwarded by the transaction terminal 301 may be the caller ID of the beneficiary phone device 317, which may be provided to the merchant by the beneficiary at the point of sale. The transaction-related information and the “other” information are collectively labeled Phone-Based Transaction Data 324b as shown.

At the charity card processor 311, the “other” transaction information communicated by both the IVR system 319 and the merchant transaction terminal 309 are used to link up the data elements associated with the transaction. The charity card processor 311 communicates with the beneficiary bank 36 to retrieve the beneficiary's account information, including the available balance in the account. The charity card processor 311 then analyzes the available account balance in conjunction with the transaction descriptor data supplied from the merchant transaction terminal 301 and the usage restrictions stored in the database 315 to determine whether there are sufficient funds in the account to pay for the transaction and whether the transaction is not blocked by any usage restriction that pertains to the account (or to the beneficiary). If these conditions are satisfied, the charity card processor 311 returns an authorization which is forwarded to the merchant transaction terminal 301. If any one of these conditions is not satisfied, the credit card processor 311 returns an error which is forwarded to the transaction terminal 301. After receiving authorization, the merchant transaction terminal 301 records the sale and prints a sales receipt that is given to the beneficiary customer. If an error is received, the sale is declined. Preferably, settlement of the sale is accomplished though a mechanism similar to that performed for credit card/debit card sales. Upon settlement, the beneficiary bank 36 charges the transaction amount against the beneficiary's account 36a and adds information pertaining to the transaction to the transaction data maintained by the beneficiary bank 36.

The usage restrictions stored in the database 315 can be defined in a flexible manner to vary across different beneficiaries. In addition, such usage restrictions can be defined to correspond to a diverse range of usage controls (e.g., “purposes”) as specified by donors during fund raising, for example as part of the electronic fund raising system described above. In this manner, the withdrawal of funds by the beneficiary using the charity card (or using the phoned-based transaction methodology as described above) can be automatically regulated to conform to the specific usage controls dictated by a given donor during fund raising.

Authentication of the beneficiary caller (or the beneficiary card holder) may be accomplished with traditional authentication mechanisms such as a PIN code or password. Alternatively, more advanced authentication mechanisms based on biometrics such as fingerprints, voice prints or retinal scans can be used. For example, in the system of FIG. 3, a voice print authentication provider 327 is operably coupled to the network 305. The voice print authentication provider 327 persistently stores voice prints for a plurality of users, one of which is the beneficiary caller or the beneficiary card holder. The IVR system 319 or another part of the system communicates a voice sample captured during the transaction to the voice print authentication provider 327, which compares the beneficiary's voice print persistently stored therein with the voice sample or portion thereof supplied thereto in order to authenticate the donor.

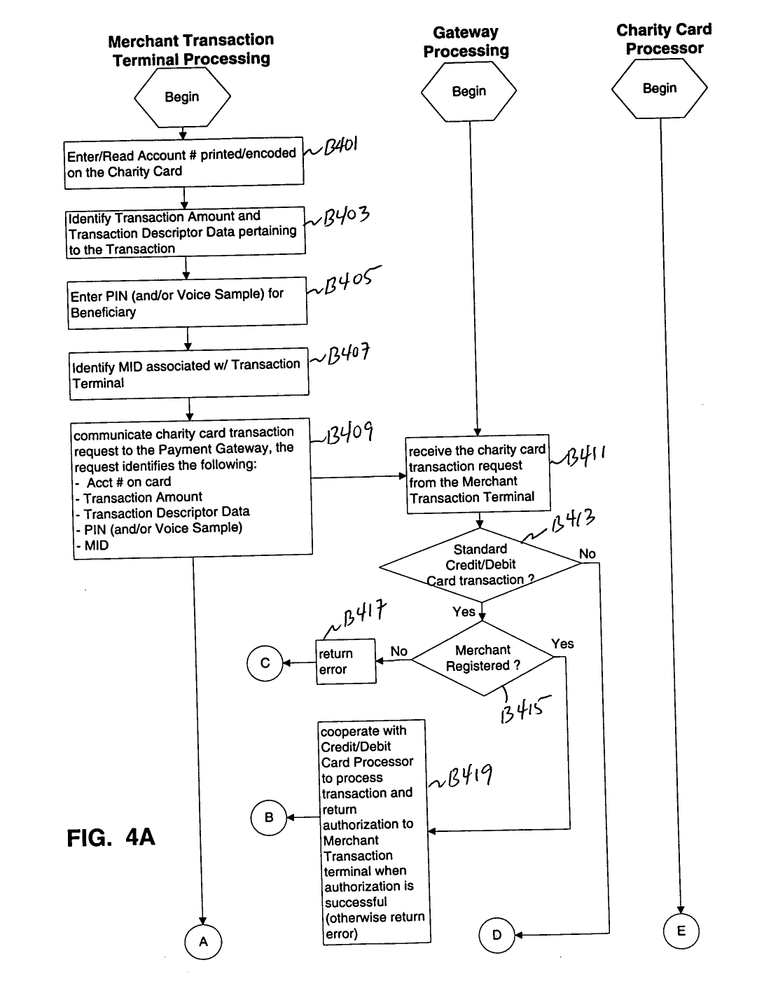

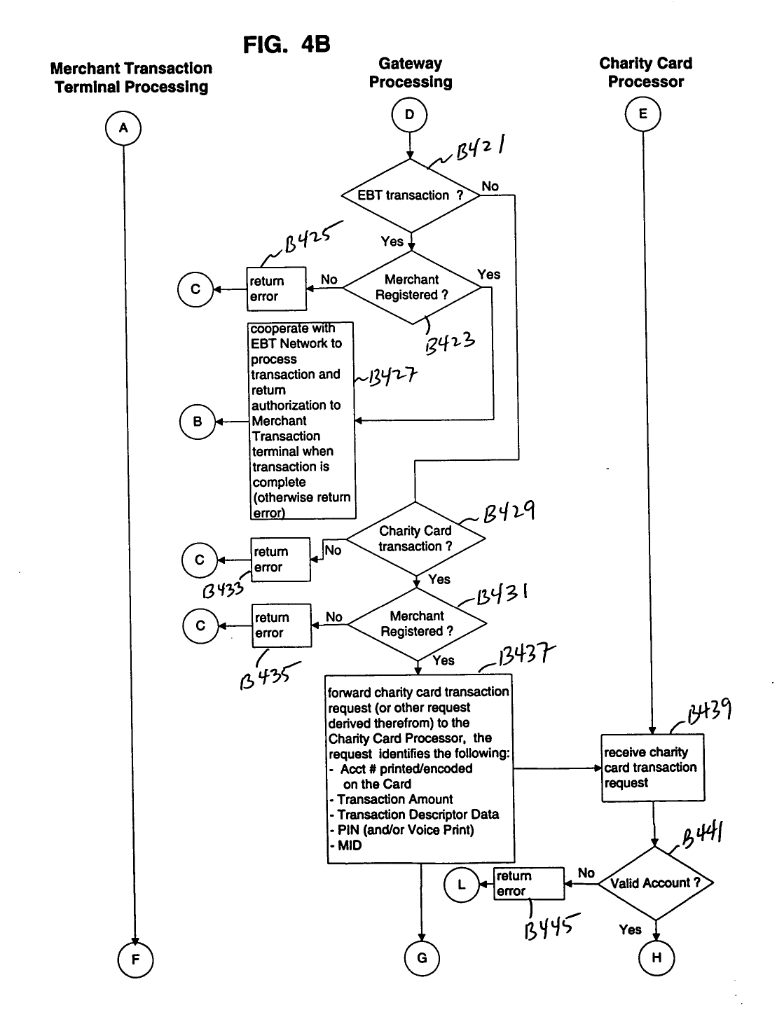

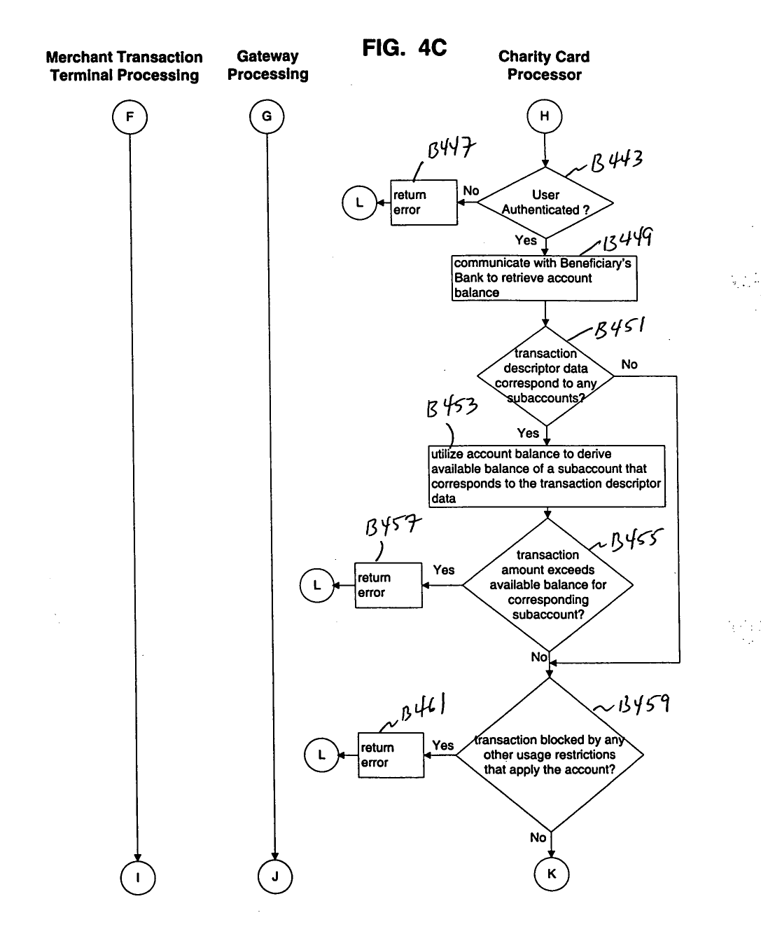

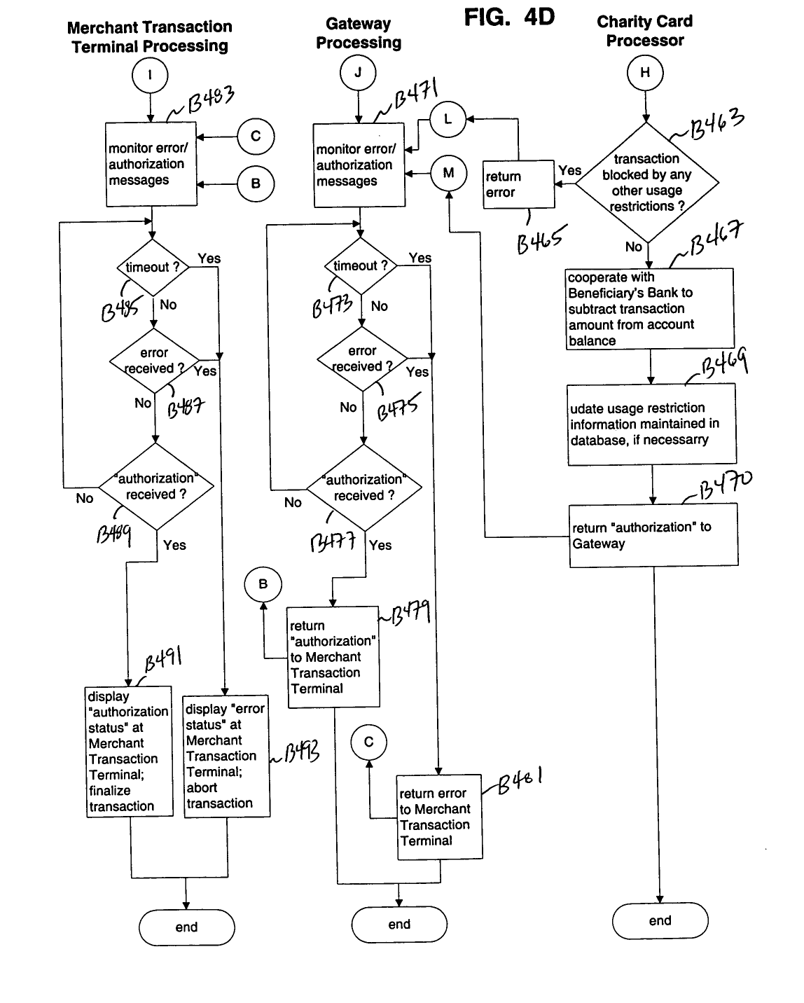

Turning now to FIGS. 4A-4D, collectively, there is shown a flow chart that illustrates exemplary operations carried out by the merchant transaction terminal, the payment processing gateway, and the charity card processor of FIG. 3 in authorizing payment of a charity card transaction in accordance with the present invention. It is assumed that the beneficiary financial institution has issued a charity card 313 to a beneficiary and the merchant transaction terminal 301 has determined the amount of the transaction (for example, by scanning a UPC bar code on an item, using the UPC code to lookup a database entry corresponding thereto that provides the price of the item, calculating the transaction amount based upon the price, and storing the transaction amount in system memory, or by entering the amount by manual data entry).

The operations begin in block B401 whereby merchant transaction terminal 301 identifies the beneficiary account number printed or encoded on the charity card 313. Such operations can be accomplished using a magnetic card reader, a smart card reader, an RFID reader, other suitable electronic means, or manually entering the account number. In block B403, the merchant transaction terminal 301 retrieves the transaction amount from system memory and also identifies the transaction descriptor data that pertains to the transaction. The transaction descriptor data may be derived from a database of descriptors that are indexed to the scanned UPC code of the item(s) to be sold, or possibly from the UPC code(s) itself.

In block B405, the merchant transaction terminal 301 interacts with the beneficiary cardholder such that the cardholder enters a PIN, a password, a voice sample, and/or some other biometric sample used for authentication purposes. In block B407, the merchant transaction terminal 301 retrieves the merchant bank identifier (MID) associated with the transaction terminal 301 and possibly other information, which are preferably stored in system memory.

In block B409, the merchant transaction terminal 301 communicates a charity card transaction request to the payment processing gateway 303 over the network 305. The request includes the data identified in blocks B401 through B407, which includes: the beneficiary account number printed/encoded on the card 311, the transaction amount, the transaction descriptor data, the PIN or other data used for authentication, and the merchant identifier (MID) and possibly other information.

The payment processing gateway 303 receives the charity card transaction request communicated from the merchant transaction terminal 301 (block B411) and checks whether the request is a standard credit/debit card transaction (block B413). The standard credit and debit card transactions are handled in blocks B413, B415, B417 and B419 as shown. For charity card transactions, this request is not considered a standard transaction and the operations continue by checking whether the request is an EBT transaction (block B421) (FIG. 4B). The EBT transactions are handled in blocks B423, B425 and B427 as shown. For charity card transactions, this check fails (i.e., EBT Transaction=No) and the operations continue by checking whether the request is a charity card transaction (block B429). For charity card transactions, this test is successful and the operations continue to block B431. If at block B431 the test is unsuccessful, an error is returned to the merchant transaction terminal (block B433).

In block B431, the gateway processing determines whether the merchant is registered for the service. Preferably, this is accomplished by maintaining a database of registered merchants (indexed by their bank account information) and cross-referencing the merchant bank information within the charity card payment request message with the database. If the test of block B431 fails, an error is returned to the merchant transaction terminal (block B435). If the test of block B431 is successful, the gateway processor 303 forwards the charity card transaction request to the charity card processor 311 (block B437). Alternatively, this check can be bypassed to allow processing without merchant registration.

The charity card processor 311 receives the charity card transaction request (block B439). The charity card processor 311 communicates with the beneficiary bank 36 to check whether the charity card 313 is valid (block B441), e.g., the beneficiary account number points to a valid cardholder account. The charity card processor 311 then authenticates the user (block B443) (FIG. 4C) using a PIN, voice print or other biometric as described above. If either of these tests fail, an error is returned to the gateway 303 (blocks B445, B447). If both of these tests are successful, the charity card processor 311 retrieves the available account balance for the beneficiary account (block B449), if not already communicated from the beneficiary bank 36, and continues to block B451.

In block B451, it is determined whether the transaction descriptor data for the charity card transaction request corresponds to any sub-accounts of the beneficiary account. Preferably, such correspondence is provided by associating restriction codes to the sub-accounts of the beneficiary account in database 315. During block B451, the database 315 is accessed to identify these restriction codes, and it is determined whether the transaction descriptor data maps to one or more of these restriction codes. Such mapping operations may utilize a table-look-up or other well known data manipulation techniques. If the test of block B451 passes, the operations continue to block B453; otherwise the operations jump to block B459.

To better understand the operations of block B451, an exemplary case where one particular sub-account of the beneficiary account 36a is restricted to allow transactions for food products only is considered. In this case, a restriction code is assigned to this specific restriction and associated with the particular sub-account in the database 315. During block B451, a table-look-up operation is performed to determine whether the transaction descriptor data, such as the UPC of the product(s) to be purchased, are food products. If this test passes, the operations continue to block B453; otherwise the operations jump to block B459.

In block B453, the database 315 is accessed to retrieve the account balance for the one or more sub-accounts that correspond to the transaction descriptor data as identified in block B451. The account balance(s) are used to derive an available balance for one or more of the sub-accounts. In block B455, it is determined whether the transaction amount exceeds the available balance. In other words, it is determined whether there is a sufficient balance in the sub-account corresponding to the particular transaction. If not, an error is returned (block B457); otherwise the operations continue to block B459.

In block B459, it is determined whether the transaction is blocked by any other usage restriction that applies to the beneficiary account 36a. Such usage restrictions can be based upon information that is part of the charity card payment request or other auxiliary information. For example, it is contemplated that such usage restrictions can restrict the transactions to one or more particular merchants. Similarly, it is contemplated that such usage restrictions can restrict the transactions to certain times of day (e.g., not after 10:00 pm). If this test fails, an error is returned (block B461). If this test passes, the operations continue to block B463.

In block B463 (FIG. 4D), it is determined whether the transaction is blocked by any other usage restrictions. If this test fails, an error is returned (block B465). If this test passes, the operations continue to block B467.

In block B467, the charity card processor 311 communicates with the beneficiary bank 36 to subtract the transaction amount from the account balance of the beneficiary account 36a, and the operations continue to blocks B469 and B470. In block B469, the usage restrictions associated with the beneficiary account 36a in the database 315 may be updated to reflect the approval of the transaction, if need be. These operations can be used, for example, to subtract from a running account balance that tracks the purchase of a specific product type. In block B470, an “authorization” message is returned to the payment processing gateway 303.

The payment processing gateway 303 monitors the messages received from the charity card processor 311 (block B471). If a timeout has occurred without the reception of an error message or authorization message (block B473), the operations continue to block B481 to return an error to the Merchant Transaction Terminal 301; otherwise the operations continue to block B475.

In block B475, if an error message is received from the charity card processor 311, the operations continue to block B481 to return an error to the Merchant Transaction Terminal 301; otherwise the operations continue to block B477.

In block B477, if an authorization message is received from the charity card processor 311, the operations continue to block B479 to return an authorization to the Merchant Transaction Terminal 301; otherwise the operations return back to block B473 to continue checking for timeout, the reception of an error message, or the reception of an authorization message.

The Merchant Transaction Terminal 301 monitors the messages received from the payment processing gateway 311 (block B483). If a timeout has occurred without the reception of an error message or authorization message (block B485), the operations jump to block B493 to display an “error status” alert at the Merchant Transaction Terminal 301 and the transaction is aborted; otherwise the operations continue to block B487.

In block B487, if an error message is received from the payment processing gateway 311, the operations jump to block B493 to display an “error status” alert at the Merchant Transaction Terminal 301 and the transaction is aborted; otherwise the operations continue to block B489.

In block B489, if an authorization message is received from payment processing gateway 303, the operations continue to block B491 to display an “authorization status” alert to the Merchant Transaction Terminal 301 and the transaction is finalized; otherwise the operations return back to block B485 to continue checking for timeout, the reception of an error message, or the reception of an authorization message.

The operations described above with respect to FIGS. 4A-4D may be readily adapted to provide payment for goods or services utilizing a telephone-based transaction. As described above, the telephone-based transaction involves data originating from both the telephony device 317 and the Merchant Transaction Terminal 301 that are linked together by the charity card processor 311 or other mechanism. The charity card processor 311 utilizes this data to access the beneficiary account 36a and the database 315 to reject or authorize the payment as described above with respect to FIGS. 4A-4D.

In addition, the logical partitioning of the functionality realized by the distributed system architecture described above with respect to FIGS. 3 through 4D may be readily modified as needed. For example, the functionality of the charity card processor 311 (and possibly the database 315) may be integrated with the functionality provided by the payment processing gateway 303. Alternatively, the functionality of the charity card processor 311 (and possibly the database 315) may be integrated with the transaction processing of the beneficiary's financial institution (bank 36). In other examples, the functionality of the payment processing gateway 303 or the voice print authentication provider 327 may be bypassed or omitted. In addition, the functionality of the voice print authentication provider 327 may also be integrated with the functionality of other components of the system, such as the payment processing gateway 303 or the charity card processor 311.

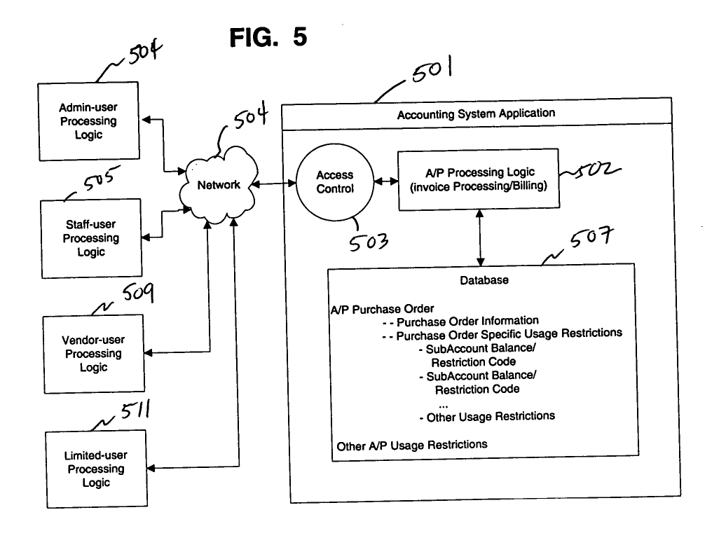

Turning now to FIG. 5, there is shown an exemplary computer-based accounting system in accordance with another aspect of the present invention. It includes a computer processing system 501 that is executing an accounting system application for a particular entity. The accounting system application includes account payable processing logic 502 in addition to access control logic 503. The account payable processing logic 502 provides functionality that allows a user to create and manage vendor information, payment scheduling and authorization (e.g., billing and invoice processing), budgeting information, and purchase order accounts. The access control logic 503 provides user-level access control to the functionality of the accounts payable processing logic 502 in accordance with a set of access control parameters set by the administrator of the system as is well known. In the exemplary embodiment shown, there are four different classes of users—Administrators, Staff, Vendors, Limited. Administrative users set up user accounts, manage the security of the system, and perform other administrative tasks. Staff users access the system to enter, view and print information that pertains to invoices or bills that are to be paid. Vendor users are associated with vendors that supply the entity with goods or services. The vendors submit invoices/bills to the entity for payment of the goods or services. The invoice/bill preferably references a purchase order number provided by the entity. In this manner, the purchase order is used to manage an internal spending account defined by the entity. Limited users have limited access to the information maintained by the system as will become evident from the description below.

Administrator users access the accounts payable processing logic 502 through administrator-user processing logic 504. Staff users access the accounts payable processing logic 502 through staff-user processing logic 505. Vendor users access the accounts payable processing logic 502 through vendor-user processing logic 509. Limited users access the accounts payable processing logic through limited-user processing logic 511. The administrator-user processing logic 504, the staff-user processing logic 505, the vendor-user processing logic 509 and the limited-user processing logic 511 are preferably coupled to the access control 503 over a network 504 as shown.

The accounting system application 501 maintains or accesses a database 507 which stores information pertaining to the purchase order accounts defined and managed by the system. The database 507 may store other information such as user information, vendor information, budget information, bill/invoice information, etc. For each purchase order account, the database 507 stores account balance information, account-specific usage restrictions and possibly other usage restrictions. These usage restrictions are used to selectively disapprove of payment of a given invoice or bill. The database 507 may be a localized data resource or may be a distributed resource such as batch of locatable files distributed across a network.

Through interaction with the staff-user processing logic 505, staff users access the accounts payable processing logic 502 to generate and/or submit (e.g., post) an invoice or bill for payment. It is possible that the vendor may present the invoice or bill to the system in electronic form, or that it is loaded into the system as part of a batch file or other data input means. The invoice/bill includes at least the following information:
i) the purchase order account number associated with the bill/invoice;
ii) the amount for the bill/invoice;
iii) descriptor data pertaining to the bill/invoice; and
iv) vendor/payee information.
   The descriptor data pertaining to the bill/invoice corresponds to the goods or services provided by the vendor/payee that pertain to the bill/invoice. For example, the descriptor data may be one or more codes assigned to the goods or services purchased as part of the transaction, or one or more codes assigned to the type of goods or services purchased as part of the transaction. Alternatively, the descriptor data may include alphanumeric text that describes the goods or services purchased as part of the transaction.

In processing a given bill/invoice, the accounts payable processing logic 502 communicates with the database 507 to verify that the purchase order account for the bill/invoice is valid. If the purchase order account is valid, the accounts payable processing logic 502 analyzes the available account balance(s) in conjunction with the transaction descriptor data generated as part of the bill/invoice and the usage restrictions stored in the database 507 to determine whether there is sufficient funds in the account to pay for the bill/invoice and whether such payment is not blocked by any usage restriction that pertain the purchase order account or to the bill/invoice. If these conditions are satisfied, the accounts payable processing logic 502 enables continued processing of the bill/invoice for payment. For example, such continued processing may provide for review of the bill/invoice by an authorized user for approval of payment, or may provide for direct payment of the bill/invoice. If the purchase order account is not valid or any of these conditions is not satisfied, the accounts payable processing logic 502 returns an error to the staff-user processing logic 505. The staff-user processing logic 505 communicates the error status to the staff-user and possibly to the vendor for the invoice/bill. In response thereto, the staff-user can provide a different purchase account number for resubmission of the invoice/bill or possibly invoke other means for resubmission of the invoice/bill for payment.

The access control logic 503 is preferably adapted to provide vendor-user access control to certain functional parts of the accounts payable processing logic 502. For example, such functional parts may provide reporting of the payment status of the invoices/bills for a particular vendor (and possibly drill down views for invoices/bills that pertain to a specific purchase order account) as well as other vendor-specific information.

The access control logic 503 is also preferably adapted to provide limited-user access control to certain functional parts of the accounts payable processing logic 502. Such functional parts may provide reporting of the budgeted account balances and/or available account balances for particular purchase order accounts or other specific information. For example, when used by a charitable entity, the Limited users of the system may be charitable donors that are granted access to particular budget account balances and/or available account balances for particular purchase order accounts that relate to the monetary funds that the donor contributed to the charitable entity. In yet another example, the Limited users of the system may be beneficiaries of the charitable entity that are granted access to particular budget account balances and/or available account balances for particular purchase order accounts that relate to the monetary funds that have been allocated for benefit of the beneficiary. In this manner, the charitable donors and/or beneficiaries can readily access the status of monetary funds managed by the charitable entity on their behalf.

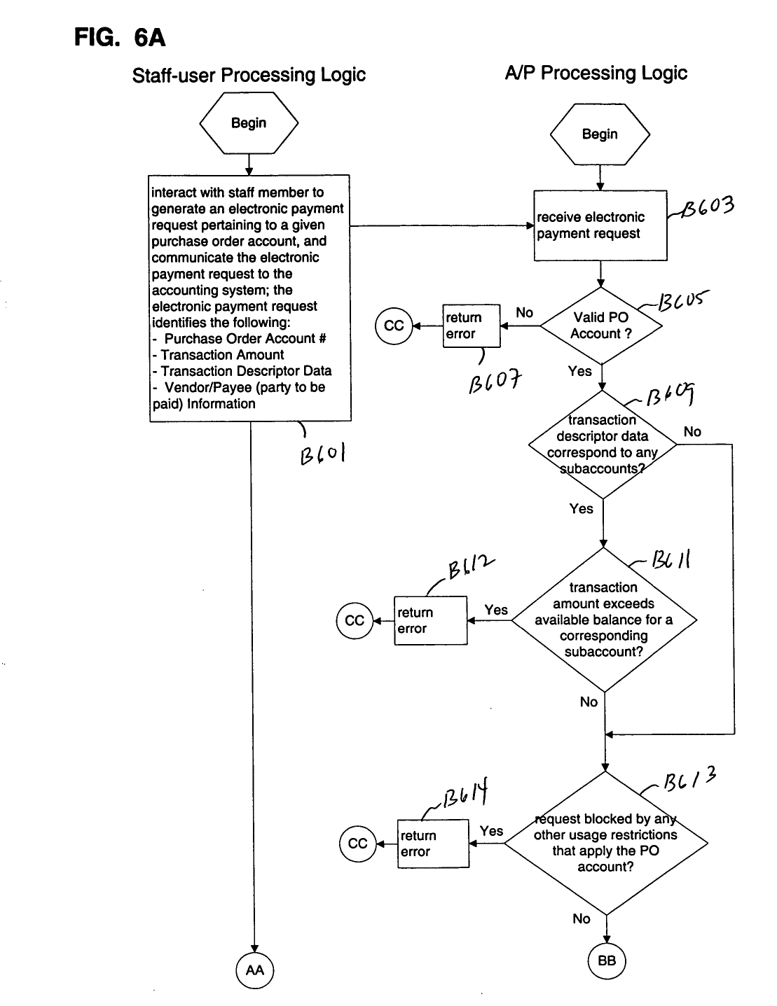

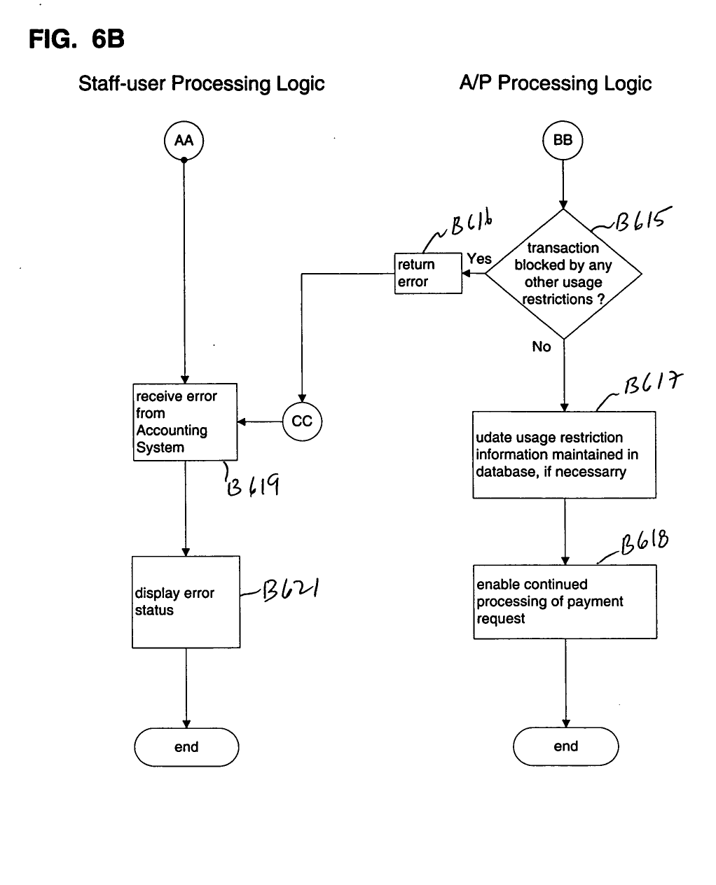

Turning now to FIGS. 6A-6B, collectively, there is shown a flow chart that illustrates exemplary operations carried out by the staff-user processing logic and the accounts payable processing logic of FIG. 5 in selectively denying payment of an invoice/bill in accordance with the present invention. The operations begin in block B601 whereby the staff-user processing logic interacts with the staff-user to generate an electronic payment request (e.g., invoice/bill payment request) that pertains to a specific purchase order account stored in the database 507. The electronic payment request may be triggered by the staff-user requesting that the invoice be “posted”, by electronic presentment of invoice/bill by the vendor, by loading the invoice into the system as part of a batch file, or by other data input means as is well known in the accounting system arts. The electronic payment request identifies the following:
i) the purchase order account number associated with the bill/invoice;
ii) the amount for the bill/invoice;
iii) descriptor data pertaining to the bill/invoice; and
iv) vendor/payee information.
   The electronic payment request is communicated from the staff-user processing logic 505 to the accounts payable processing logic 502 via the access control logic 503.

The accounts payable processing logic 502 receives the electronic payment request (block B603) and checks whether the purchase order account for the request is valid (block B605). If this test fails, an error is returned to the staff-user processing logic 505 (block B607). If this test is successful, it is determined whether the transaction descriptor data for the request corresponds to any sub-accounts of the purchase order account (block B609). Preferably, such correspondence is provided by associating restriction codes to the sub-accounts of the purchase order account in database 507. During block B609, the database 507 is accessed to identify these restriction codes, and it is determined whether the descriptor data of the request maps to one or more of these restriction codes. Such mapping operations may utilize a table-look-up or other well known data manipulation techniques. If the test of block B609 passes, the operations continue to block B611; otherwise the operations jump to block B613.

In block B611, the database 507 is accessed to retrieve the account balance for the one or more sub-accounts that correspond to the descriptor data as identified in block B609. The account balance(s) are used to derive an available balance for one or more of the sub-accounts. It is then determined whether the transaction amount exceeds the available balance. In other words, it is determined whether there is a sufficient balance in the purchase order account or sub-account corresponding to the particular transaction. If not, an error is returned (block B612); otherwise the operations continue to block B613.

In block B613, it is determined whether payment of the given invoice/bill is blocked by any other usage restriction that applies to the purchase order account. Such usage restrictions can be based upon information that is part of the payment request or other auxiliary information. If this test fails, an error is returned (block B614). If this test passes, the operations continue to block B615.

In block B615 (FIG. 6B), it is determined whether the transaction is blocked by any other usage restrictions. If this test fails, an error is returned (block B616). If this test passes, the operations continue to blocks B617 and B618.

In block B617, the usage restrictions associated with the purchase order account (or vendor) in the database 315 may be updated to reflect the approval of the transaction, if need be. These operations can be used, for example, to subtract from a running account balance that tracks the purchase of a specific product type.

In block B618, the accounts payable processing logic enables continued processing of the payment request. For example, such continued processing may provide for review of the bill/invoice by an authorized user for approval of payment, or may provide for direct payment of the bill/invoice.

The staff-user processing logic 505 monitors the messages received from the application 501. When an error message is received from the processing logic 502 (block B619), the operations continue to display an “error status” alert at the workstation that is executing the staff-user processing logic 505 (block B621).

Advantageously, the improved accounting systems as described above with respect to FIGS. 5-6B may be adapted for use in a charitable organization to enable the charity to control the outflow of funds managed therein in accordance with specific donor purposes that are tied to particular donated monies as described above. In this configuration, the structure of the purchase order accounts/sub-accounts and the usage restrictions associated therewith are tailored to the specific donor purposes. The bills/invoices to be paid by the charitable organization are assigned to the corresponding purchase order accounts. For a given bill/invoice, the usage restriction(s) for the corresponding purchase order account, or other usage restrictions, are utilized for automatic and selective disapproval of payment of the given invoice or bill.

In this configuration, the limited-user processing logic 511 and the access control logic 503 may be adapted to enable a donor or beneficiary to generate reports of the budgeted account balances and/or available account balances for particular purchase order accounts, or other specific information, that pertain to the donor or beneficiary. It is contemplated that such donor access will enable a donor to monitor the amount and usage of the funds that he or she has donated as it is allocated and used by the charity organization.

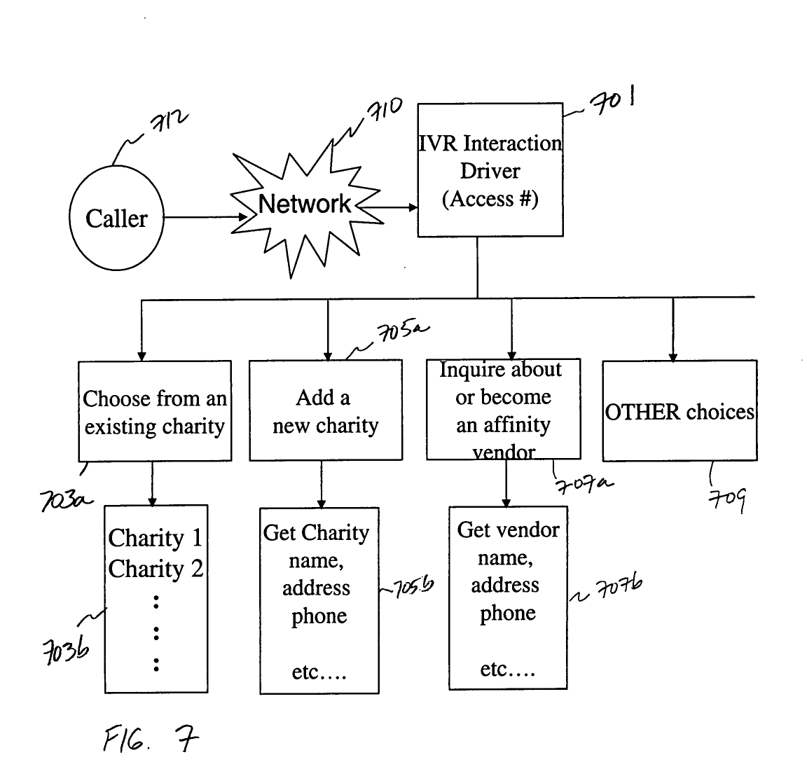

In yet another aspect of the present invention, the IVR system 12 of FIG. 1A can be readily adapted to operate as a donation hotline that supports donation transactions for a number of different charities. An exemplary architecture of such an IVR system is shown in FIG. 7 including an IVR interaction driver 701 that is coupled to a telecommunications network 710. A telephone access number is associated with the IVR interaction driver 701. Callers 712 place a call to this telephone access number, which is routed over the telecommunications network 710 to the IVR interaction driver 701. The IVR interaction driver 701 answers the call and interacts with the caller by a menu structure and associated voice scripts as is well known. One of the menu options (labeled 703a, 703b) allows the caller to choose from a number of charitable entities. Upon selection of one of the charitable entities in block 703b, the IVR system proceeds to conduct a donation transaction between the caller and the selected charitable entity as described above with respect to FIG. 1A. Another one of the menu options (labeled 705a, 705b) allows the caller to add a new charity to the hotline service. In the processing of block 705b, the caller enters the required information for the charity (name, address, phone, account, etc). Yet another one of the menu options (labeled 707a, 707b) allows an entity to inquire or become an affinity vendor for the donation hotline. In the processing of block 707b, the caller enters the required information for the affinity vendor (name, address, phone, account, etc). The goods or services provided by the affinity vendor are marketed and/or sold in conjunction with the donation transaction processing afforded by the IVR system 12. It is contemplated that the IVR system 12 will maintain a database of the transactions for the goods/services accomplished via interaction with the IVR system 12, and automatically charge fees (such as advertising fees, commission fees and/or other fees) for such services to the affinity vendor preferably on a periodic basis (such as a monthly basis). Finally, the menu structure of the IVR system may allow for additional choices in block 709. The donation hotline architecture of FIG. 7 can also be used for automatic voice-based processing for political donations. Advantageously, the donation hotline architecture of FIG. 7 allows a single access number to support multiple charitable or political entities, which reduces the telecommunication fees associated with the services. It also provides for automatic interaction with a plurality of callers at all times of the day and week without human involvement on the part of the transaction processing entity during the transaction process. This feature avoids the high costs associated with traditional operator-assisted donation transaction methodologies.

There have been described and illustrated herein several embodiments of an electronic fund-raising system, electronic transaction processing system, computer-based accounting system, and corresponding methods of operation. While particular embodiments of the invention have been described, it is not intended that the invention be limited thereto, as it is intended that the invention be as broad in scope as the art will allow and that the specification be read likewise. Thus, while particular configurations have been disclosed in reference to charitable fund-raising and charitable fund-distribution applications, it will be appreciated that the systems and methodologies described herein are readily applicable to other applications, such as political fund raising, money transfer, electronic bill payment, electronic tuition payment, public event information, registration and payment, as well as electronic distribution of funds for the benefit of individuals, such as family members. In addition, the source of donor funds that is accessible for transfer can include other types of accounts, such as brokerage accounts and personal philanthropic foundations. In addition, while the preferred embodiment described herein utilizes an interactive voice response system for automatic interaction with users of the system, it will be appreciated that a web-based solution can be used whereby interaction occurs between a user and web server over the Internet, whereby the web-server embodies the functionality of the interactive voice response system. Data communication between the processing elements described herein can be carried out over any of a number of different distributed programming methodologies, such as remote procedure call stubs, message oriented middleware, object request broker (ORB) technology, distributed computing environment (DCE) services, COM/DCOM services, and the like. Additionally, the automatic transaction processing methodology described herein for merchant transactions can be adapted to allow for human intervention. In such circumstances, approval of a given transaction can be accomplished by interaction between the merchant and an operator over a phone-based connection, SMS messages, an instant messaging session or other person-to-person and/or person-to-machine communication mechanisms. Similarly, the other transaction processing methodology described herein can be accomplished over phone-based connections, SMS messages, instant messaging sessions, other person-to-person or person-to-machine communication mechanisms. It will therefore be appreciated by those skilled in the art that yet other modifications could be made to the provided invention without deviating from its spirit and scope as set forth herein.

1. A system for managing and conducting electronic-based funds transfers comprising:
an interactive system that interacts with a user to conduct a transaction of monetary funds from an account associated with the user, including means for recording data pertaining to at least one of the following:
i) usage control information which controls the manner in which the transferred monetary funds are used downstream in the usage chain;
ii) usage monitoring information which controls the manner in which a party can monitor the use of the transferred monetary funds downstream in the usage chain; and
iii) payee account information that identifies a financial account into which the monetary funds of the transaction are to be transferred.

2. A system according to claim 1, further comprising:
means for authenticating said at least one user utilizing a voice print of said at least one user.

3. A system according to claim 1, wherein:
said interactive system comprises an interactive voice response system that is operably coupled to said users over a telecommunications network.

4. A system according to claim 3, wherein:
said interactive voice response system includes means for recording spoken voice of said users as part of said transactions and storing a representation of said spoken voice as a file in a database for subsequent access thereto.

5. A system according to claim 1, wherein:
said interactive system comprises a web server that is operably coupled to said users over the Internet.

6. A system according to claim 5, wherein:
the recorded data comprises information supplied by said users over the Internet.

7. A system according to claim 1, further comprising:
data entry means providing playback of spoken voice recorded during a particular transaction, manual entry of alphanumeric data corresponding to such spoken voice, and storage of such alphanumeric data in a database, wherein the recorded data is part said alphanumeric data.

8. A system according to claim 1, wherein:
said system is adapted for use in one of the following applications, including
charitable fund raising;
political fund raising;
money transfer between a payor and a payee;
electronic bill payment;
electronic tuition payment; and
public event information, registration and payment.

9. A system according to claim 1, further comprising:
a transaction processing subsystem, operably coupled to said interactive system, that carries out said transaction in conjunction with real-time communication with said interactive system.

10. A system according to claim 1, further comprising:
means for controlling access to the transferred monetary funds, wherein access to the transferred monetary funds are made available to a party that has partial or complete discretionary access to such funds.

11. A system for managing and conducting electronic-based charitable fund raising comprising:
an interactive voice system that interacts with charitable donors to conduct transactions of monetary funds from accounts associated with said donors, including means for recording spoken voice of said donors as part of said transactions and storing a representation of said spoken voice as a file in a database for subsequent access thereto, wherein portions of said spoken voice represent usage restrictions that are applicable to subsequent usage of said monetary funds.

12. A system according to claim 11, wherein:
said portions of said spoken voice represent a specific purpose that is applicable to said monetary funds.

13. A system according to claim 12, further comprising:
means for converting said portions of said spoken voice to data that represents usage restrictions that are applicable to said monetary funds subsequent to said transactions; and
a database that records said data.

14. A system according to claim 13, further comprising:
data entry means providing playback of spoken voice recorded during a particular transaction, manual entry of alphanumeric data corresponding such spoken voice, and storage of such alphanumeric data in a database.

15. A system according to claim 14, wherein:
said database is adapted to enable donor access over a network.

16. In a system for conducting an electronic-based transaction including a transaction processing terminal and an account storing funds for a particular entity, wherein payment for the transaction is to be made from the account, a payment processor comprising:
input logic that is adapted to receive transaction request data communicated from said transaction processing terminal, said transaction request data including a transaction amount for the transaction and transaction descriptor data associated with goods or services that are part of the transaction;
decision logic that is adapted to selectively authorize the transaction based upon analysis of the received transaction amount and said transaction descriptor data in conjunction with balance information and at least one usage restriction for the account; and
output logic that is adapted to generate a status message based upon the analysis performed by said decision logic for communication back to the transaction processing terminal.

17. A payment processor according to claim 16, wherein:
said status message comprises an authorization message in the event that said decision logic determines that the balance information indicates that an available balance for the account exceeds the received transaction amount and the transaction is not blocked by any usage restriction for the account.

18. A payment processor according to claim 16, wherein:
said status message comprises an error message in the event that said decision logic determines that the balance information indicates that an available balance for the account is less than the received transaction amount.

19. A payment processor according to claim 16, wherein:
said status message comprises an error message in the event that said decision logic determines that the transaction is blocked by a usage restriction for the account.

20. A payment processor according to claim 16, further comprising:
a database storing said at least one usage restriction for the account.

21. A payment processor according to claim 20, wherein:
said at least one usage restriction comprises at least one restriction code associated with the account.

22. A payment processor according to claim 21, wherein:
said decision logic maps the received transaction descriptor data to at least one corresponding restriction code and checks whether the derived at least one restriction code matches the at least one restriction code associated with the account.

23. A payment processor according to claim 22, wherein:
said status message comprises an authorization message in the event that said decision logic determines that the balance information indicates that an available balance for the account exceeds the received transaction amount and that the derived at least one restriction code does not match any restriction code associated with the account.

24. A payment processor according to claim 22, wherein:
said status message comprises an error message in the event that said decision logic determines that the derived at least one restriction code does match a restriction code associated with the account.

25. A payment processor according to claim 16, wherein:
said transaction request data includes account data that identifies the account of the particular entity.

26. A payment processor according to claim 25, wherein:
the account is maintained by a financial institution, and the transaction involves the purchase of goods or services at a merchant.

27. A payment processor according to claim 26, wherein:
the account is an internal account maintained by an entity, and the transaction involves the purchase of goods or services by the entity.

28. A payment processor according to claim 27, wherein:
said account data is persistently stored in a hand-held card and transferred to said transaction processing terminal for communication to said payment processor during the transaction.

29. A payment processor according to claim 28, wherein:
said hand-held card utilizes magnetic means or semiconductor memory means to persistently store said account data.

30. A payment processor according to claim 27, wherein:
said account data is persistently stored by electronic means and transferred to said transaction terminal for communication to said payment processor during the transaction.

31. A payment processor according to claim 30, wherein:
said electronic means comprises a radio-frequency identification circuitry.

32. A payment processor according to claim 31, wherein:
said account data is communicated to said payment processor in response to user interaction with an interactive voice response system during the transaction.

33. A payment processor according to claim 16, wherein:
said transaction descriptor data comprises alphanumeric data that identifies the goods or services that are part of the transaction.

34. A payment processor according to claim 16, wherein:
said transaction terminal comprises at least one of point of sale machine, a computer processing machine, a personal digital assistant, and a phone.

35. A payment processor according to claim 16, for use in one of the following applications, including:
electronic distribution of funds for the benefit of beneficiaries of a charitable entity;
management of monetary funds by an entity;
electronic distribution of funds for the benefit of political candidates;
electronic distribution of funds for the benefit family members; and
electronic distribution of funds for the benefit of employees.

36. A system for conducting an electronic-based transaction comprising:
a transaction processing terminal;
an account storing funds for a particular entity, wherein payment for the transaction is to be made from the account; and
a payment processor, operably coupled to said transaction processing terminal over a communication network, including
input logic that is adapted to receive transaction request data communicated from said transaction processing terminal, said transaction request data including a transaction amount for the transaction and transaction descriptor data associated with goods or services that are part of the transaction,
decision logic that is adapted to selectively authorize the transaction based upon analysis of the received transaction amount and said transaction descriptor data in conjunction with balance information and at least one usage restriction for the account, and
output logic that is adapted to generate a status message based upon the analysis performed by said decision logic for communication back to the transaction processing terminal;
wherein said transaction processing terminal receives said status message and communicates an alert message corresponding thereto for finalizing or terminating the transaction.

37. A system according to claim 36, wherein:
said status message comprises an authorization message in the event that said decision logic determines that the balance information indicates that an available balance for the account exceeds the received transaction amount and the transaction is not blocked by any usage restriction for the account.

38. A system according to claim 36, wherein:
said status message comprises an error message in the event that said decision logic determines that the balance information indicates that an available balance for the account is less than the received transaction amount.

39. A system according to claim 36, wherein:
said status message comprises an error message in the event that said decision logic determines that the transaction is blocked by a usage restriction for the account.

40. A system according to claim 36, wherein:
said transaction request data includes account data that identifies the account of the particular entity.

41. A system according to claim 40, wherein:
the account is maintained by a financial institution, and the transaction involves the purchase of goods or services at a merchant.

42. A system according to claim 40, wherein:
the account is an internal account maintained by an entity, and the transaction involves the purchase of goods or services by the entity.

43. A system according to claim 41, further comprising:
a hand-held card issued by said financial institution that persistently stores said account data, wherein said hand-held card cooperated with said transaction terminal to communicate said account data to said payment processor during the transaction.

44. A system according to claim 43, wherein:
said hand-held card utilizes magnetic means or semiconductor memory means to persistently store said account data.

45. A system according to claim 41, further comprising:
electronic means that persistently stores said account data; and
means for transferring said account data to said transaction terminal for communication to said payment processor during the transaction.

46. A system according to claim 45, wherein:
said electronic means comprises a radio-frequency identification circuitry.

47. A system according to claim 40, further comprising:
an interactive voice response system that interacts with a user to generate said account data and communicate said account data to said payment processor during the transaction.

48. A system according to claim 36, for use in one of the following applications, including:
electronic distribution of funds for the benefit of beneficiaries of a charitable entity;
an accounting system for management of monetary funds by an entity;
electronic distribution of funds for the benefit of political candidates;
electronic distribution of funds for the benefit of family members; and
electronic distribution of funds for the benefit of employees.

49. A method for conducting an electronic-based transaction in a system including a transaction processing terminal and an account storing funds for a particular entity, wherein payment for the transaction is to be made from the account, the method comprising:
receiving transaction request data communicated from said transaction processing terminal, said transaction request data including a transaction amount for the transaction and transaction descriptor data associated with goods or services that are part of the transaction;
selectively authorizing the transaction based upon analysis of the received transaction amount and said transaction descriptor data in conjunction with balance information and at least one usage restriction for the account; and
generating a status message based upon said analysis for communication back to the transaction processing terminal.

50. A method according to claim 49, wherein:
said status message comprises an authorization message in the event that said analysis determines that the balance information indicates that an available balance for the account exceeds the received transaction amount and the transaction is not blocked by any usage restriction for the account.

51. A method according to claim 49, wherein:
said status message comprises an error message in the event that said analysis determines that the balance information indicates that an available balance for the account is less than the received transaction amount.

52. A method according to claim 49, wherein:
said status message comprises an error message in the event that said decision logic determines that the transaction is blocked by a usage restriction for the account.

53. A method according to claim 49, wherein:
said transaction request data includes account data that identifies the account of the particular entity.

54. A method according to claim 53, wherein:
the account is maintained by a financial institution, and the transaction involves the purchase of goods or services at a merchant.

55. A method according to claim 53, wherein:
the account is an internal account maintained by an entity, and the transaction involves the purchase of goods or services by the entity.

56. A method according to claim 54, further comprising:
a hand-held card issued by said financial institution that persistently stores said account data, wherein said hand-held card cooperated with said transaction processing terminal to communicate said account data to said payment processor during the transaction.

57. A method according to claim 56, wherein:
said hand-held card utilizes magnetic means or semiconductor memory means to persistently store said account data.

58. A method according to claim 54, wherein:
electronic means persistently stores said account data, which is transferred to said account data to said transaction terminal for communication to said payment processor during the transaction.

59. A method according to claim 58, wherein:
said electronic means comprises a radio-frequency identification circuitry.

60. A method according to claim 49, further comprising:
controlling an interactive voice response system to interact with a user to generate said account data and communicate said account data to said payment processor during the transaction.

61. A method according to claim 49, for use in one of the following applications, including:
electronic distribution of funds for the benefit of beneficiaries of a charitable entity;
an accounting system for management of monetary funds by an entity;
electronic distribution of funds for the benefit of political candidates;
electronic distribution of funds for the benefit of family members; and
electronic distribution of funds for the benefit of employees.

62. A system for conducting electronic-based charitable or political donations comprising:
an interactive voice system that has a telephone access number associated therewith, said interactive voice system adapted to interact with a caller to select a particular charitable or political entity from a plurality of charitable or political entities and to conduct a transaction of monetary funds from an account associated with the caller to an account associated with the selected charitable or political entity.

63. A system according to claim 62, further comprising:
means for presenting affinity advertisements in conjunction with the interactions with the caller that conduct the transaction.

64. A system according to claim 62, further comprising:
means for offering goods for sale in conjunction with the interactions with the caller that conduct the transaction.

65. A system according to claim 62, further comprising:
means for registering a charitable or political entity into the system via interaction with the caller.

66. A method for conducting electronic-based charitable or political donations comprising:
i) providing an interactive voice system that has a telephone access number associated therewith;
ii) at the interactive voice system, receiving a call to the telephone access number by a caller;
iii) at the interactive voice system, in response to the receipt of the call, interacting with the caller to select a particular charitable or political entity from a plurality of charitable or political entities; and
iv) at the interactive voice system, upon selection of the particular charity or political entity, interacting with the caller to conduct a transaction of monetary funds from an account associated with the caller to an account associated with the selected charitable or political entity.

67. A method according to claim 66, further comprising:
v) t the interactive voice system, presenting affinity advertisements in conjunction with the interactions with the caller.

68. A method according to claim 66, further comprising:
v) at the interactive voice system, offering goods for sale in conjunction with the interactions with the caller.

69. A method according to claim 66, further comprising:
v) at the interactive voice system, interacting with the caller to register a charitable or political entity into the system.

70. A method according to claim 69, wherein:
the operations of v) bypass the operations of iii) and iv).
